(19) United States
(12) Patent Application Publication
(10) Pub. No.: US 2022/0001832 A1
(43) Pub. Date: Jan. 6, 2022

(54) SAFETY BELT AND METHOD FOR PRODUCING A SAFETY BELT

(71) Applicant: ZF AUTOMOTIVE GERMANY GMBH, Alfdorf (DE)

(72) Inventors: Martina RAUSCH, Remshalden (DE); Anna-Lena WEBER GEB. PROTT, Geldersheim (DE)

(21) Appl. No.: 17/280,903

(22) PCT Filed: Sep. 27, 2019
(86) PCT No.: PCT/EP2019/076179

§ 371 Date: Mar. 28, 2021

(30) Foreign Application Priority Data
Oct. 1, 2018 (DE) 10 2018 124 240.9

(51) Int. Cl. B60R 22/12; D03D 1/00; D03D 3/02; D03D 15/283; B60H 1/22

(52) U.S. Cl. CPC B60R 22/12; D03D 1/0005; D10B 2505/122; D03D 15/283; B60H 1/2215; D03D 3/02

(57) ABSTRACT

The invention provides a seat belt (10) for a motor vehicle comprising a webbing (12) that includes at least one chamber (24) in which at least one electric, especially band-shaped, heating element (26) is accommodated. The invention further provides a method for manufacturing such seat belt (10).

### TECHNICAL FIELD

The invention relates to a seat belt for a motor vehicle. Furthermore, the invention relates to a method for manufacturing a seat belt for a motor vehicle.

### BACKGROUND

Seat belts for motor vehicles include a webbing that is usually made from a woven fabric, for example from PET. In general, a seat belt serves to fix a vehicle occupant on the vehicle seat, if the is vehicle strongly decelerated and corresponding forces act upon the vehicle occupant. The seat belt may further be part of a safety system which, inter alia, comprises a belt tensioner so that the seat belt, especially the webbing, is tensioned in case a crash or the like is imminent. This ensures the vehicle occupant to be fixed to the vehicle seat via the seat belt at an early stage.

Typically, the seat belt itself has no additional functions, however.

Moreover, for a conventional motor vehicle it is known that the passenger compartment is heated by means of the waste heat of the internal combustion engine so that the vehicle occupants are warmed via the atmosphere in the passenger compartment. In electric vehicles, on the other hand, the required heating capacity must be provided by the vehicle battery which additionally provides the electrical energy for operating the electric motor.

Based on the electric heating capacity, the available cruising range of the electric vehicle is reduced, however, when the heating is operating. Therefore, a heating system is desired which requires as little electrical power as possible and still does not impair the occupants' comfort.

### SUMMARY

It is the object of the invention to provide a possibility of efficiently warming a vehicle occupant.

In accordance with the invention, the object is achieved by a seat belt for a vehicle comprising a webbing that includes at least one chamber in which at least one electric, especially band-shaped, heating element is accommodated. Insofar, it is provided according to the invention to place the heat source or, resp., the heating unit provided by the electric heating element closer to the vehicle occupant so that the vehicle occupant can be efficiently warmed. This is possible as, according to the invention, the air in the passenger compartment of the vehicle need not be warmed via the heating system. Thus, the heating capacity required is considerably reduced, as the vehicle occupant is warmed directly through the seat belt, especially through the electric heating element accommodated in the at least one chamber.

In order to be able to control the heat distribution especially efficiently, there may be provided plural chambers in each of which at least one electric heating element is accommodated. The individual electric heating elements can be driven especially independently of each other so that a proper heat distribution can be adjusted. Especially, the plural chambers are arranged in parallel to each other.

The plural chambers can be arranged to be distributed over the width of the webbing so that the heating capacity can be varied over the width of the webbing. Insofar, one chamber extends over a partial width of the webbing only.

Further, plural chambers in each of which at least one electric heating element is accommodated can be arranged successively in the longitudinal direction of the webbing. The heating capacity can be equally correspondingly varied in this way. It may further be provided that in one chamber in the longitudinal direction plural heating elements are successively arranged or one heating element having plural heating portions is arranged. The plural heating elements or the plural heating portions can be driven especially independently of each other.

Basically, the at least one chamber can extend over the total length or else merely over a partial area of the webbing in the longitudinal direction. The at least one chamber moreover can have a width of 3 to 5 mm. This enables a desired portion of the webbing to exhibit a defined heating profile. If the heating element extends over a partial area or a section of the webbing, an as efficient warming of the vehicle occupant as possible is safeguarded, because areas of the webbing that are not adjacent to the vehicle occupant's body are not warmed.

In general, this allows the electrical power being consumed to be utilized as efficiently as possible, if it is not necessary to heat the entire webbing, and especially areas which are not adjacent to the vehicle occupant's body.

The heating element can extend over the entire length of the chamber or over a partial length of the chamber.

The width of the heating elements may be adapted to the width of the chambers and thus may range from 3 to 5 mm. In other words, the heating elements equally have a corresponding width so that they can be easily handled, especially when manufacturing the seat belt.

The electric heating element may comprise at least one carrier on which the at least one heating material is disposed. The carrier serves to stabilize the heating element, especially when the heating element comprises a flexible heating material. In addition, especially a band-shaped carrier ensures the heating element to be easily introduced during the weaving process, when the webbing is manufactured. The carrier may be a non-woven or may consist of a fabric material.

The heating material may be especially loop-shaped. This enables both ends of the heating material to be contacted at the same end of the heating element. The two free ends of the heating material are assigned to the same end of the heating element, as the heating material is disposed in loop shape. Insofar, only one electrical interface at which an electric contact is applied to the heating element has to be provided for the electric heating element. Manufacture and assembly are facilitated accordingly.

For fixing the heating material on the carrier, said heating material may have been embroidered and/or applied by means of crochet galloon technique onto the carrier. This guarantees simple and cost-efficient manufacture of the heating element. Furthermore, the electric heating element thus can be easily introduced during the weaving process of the webbing so that said it does not have to be introduced manually afterwards.

The heating material can be insulated at least in some areas, especially an insulated heating material can be provided. As an insulated heating material, a conductive fiber element and/or a conductive stranded element can be provided. As a conductive fiber and/or stranded element, for example at least one metal strand such as a steel strand including copper coating and/or a copper strand, and/or a carbon fiber and/or a heating yarn including an enamel insulation can be provided. Accordingly, the safety is increased, as, due to the insulation, the electrically conductive material cannot be exposed to water or other liquids. Further, said insulation protects against mechanical impact such as, e.g., abrasion.

Also, at least some areas of the heating element can be insulated, especially can be provided with an insulating coating and/or sheathed with a separate insulation.

The seat belt may include an end fitting on which an electrical contact is applied to the electric heating element. An electrical contact is applied to the end side of the electric heating element in a simple manner, for which purpose the end fitting is basically suited, as typically the latter is not provided in the motion area of the vehicle occupants so that any inadvertent damaging can be effectively prevented. Moreover, further components of the seat belt which have a more complex design and less free construction space such as, e.g., the retractor can remain unchanged.

Furthermore, according to the invention, the object is achieved by a method for manufacturing a seat belt for a motor vehicle, wherein a webbing and at least one electric, especially band-shaped, heating element are provided. Then the electric heating element is arranged in the at least one chamber of the webbing.

The afore-mentioned advantages are analogously resulting for the method, as here a seat belt comprising an electric heating system is provided which, when the vehicle occupant is wearing the seat belt, is in direct vicinity of the vehicle occupant so that the latter can be warmed more efficiently than in the case of heating the entire passenger compartment.

Basically, an electric heating system is thus integrated in the seat belt.

The webbing can be fabricated together with the electric heating element during a weaving process. This allows quicker manufacture of the seat belt with the integrated heating system which is provided through the electric heating element.

In particular, the electric heating element is continuously fed to the weaving process of the webbing. In this way, continuous fabrication of the webbing without manual, especially subsequent, introduction of the heating element is possible, thus allowing a correspondingly quicker and more cost-efficient manufacture of the seat belt.

During weaving of the webbing, the electric heating element thus can be directly integrated in the webbing which, for this purpose, includes at least one appropriate chamber in which the electric heating element is accommodated and, resp., arranged during the weaving process.

Insofar, the electric heating element is then fastened in the webbing due to the weaving operation or weaving process.

The electric heating element may comprise a carrier and a heating material that is embroidered onto the carrier. The carrier serves to stabilize the electric heating element so that an appropriately flexible heating material can be used.

For efficient and quick fabrication, the electric heating element can especially be prefabricated.

Furthermore, at least some areas of the electric heating element may be insulated, especially the heating material. Thus, the electric heating element can be protected, inside the webbing, against external influences such as water and/or sweat.

Especially, plural chambers in each of which an electric heating element is arranged can be provided side by side and successively via the webbing.

If the webbing comprises plural electric heating elements, they can be driven especially independently of each other, which allows a total heating capacity and, resp., a heating surface to be easily adjusted.

### BRIEF DESCRIPTION OF THE FIGURES

Further advantages and characteristics of the invention will be evident from the following description and the drawings which will be referred to, and wherein:

FIG. 1 shows a schematic view of a seat belt according to the invention comprising a webbing; and

FIG. 2 shows a schematic sectional view of a portion of the webbing of a seat belt according to the invention.

### DETAILED DESCRIPTION

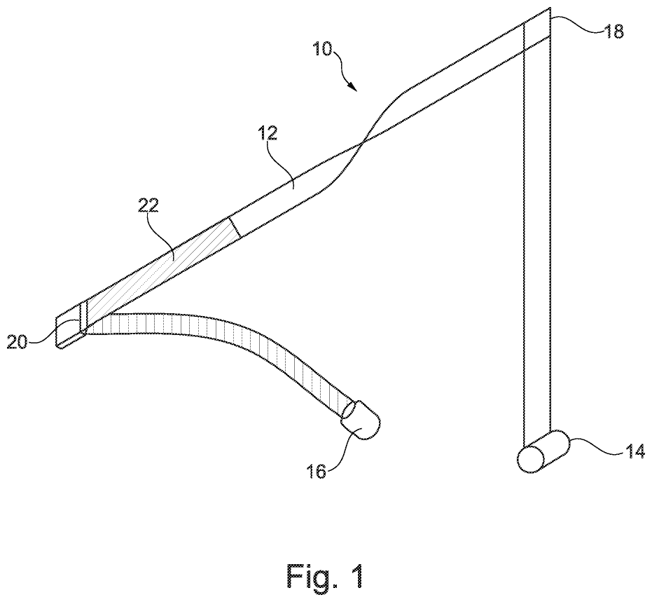

FIG. 1 illustrates a seat belt 10 for a motor vehicle comprising a webbing 12 the one end of which is assigned to a webbing retractor 14 and the second end of which is assigned to an end fitting 16.

Moreover, the seat belt 10 comprises a deflecting device 18 via which the webbing 12 is appropriately deflected.

In addition, a plug tongue 20 through which the webbing 12 is passed is movably arranged at the webbing 12.

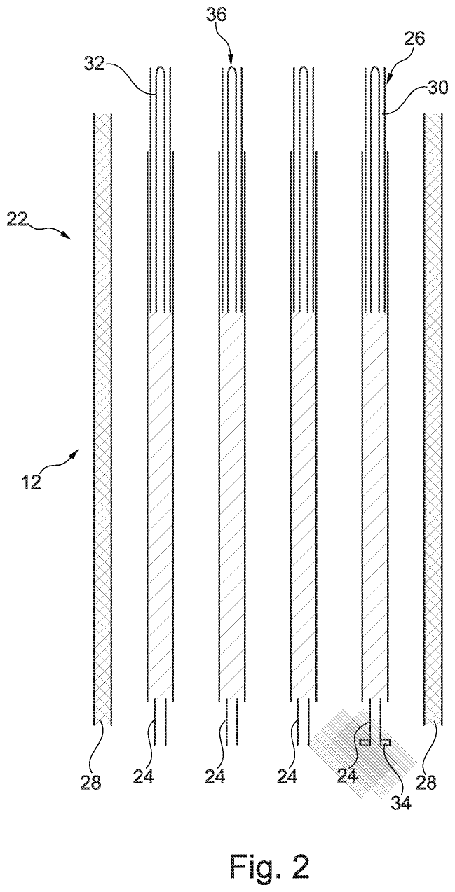

The webbing 12 additionally includes a portion 22 comprising plural chambers 24, as is visible from FIG. 2.

In each of the chambers 24 an electric heating element 26 is introduced. The chambers 24 are arranged side by side and in parallel to each other, with the chambers 24 extending in the longitudinal direction of the webbing 12.

Further, the chambers 24 may also be arranged successively in the longitudinal direction of the webbing 12.

In addition, the chambers 24 may be arranged successively in the transverse direction of the webbing 12.

Accordingly, the chambers 24 can be provided to be substantially three-dimensionally distributed within the webbing 12.

The electric heating elements 24 arranged in each of the chambers 24 serve for the heating of a vehicle occupant who is wearing the seat belt 10, especially the webbing 12, during traveling.

The webbing 12 may include plural chambers 24 that extend over the entire length of the webbing 12 or over a partial area of the webbing 12 only. In particular, the webbing 12 may include plural parallel chambers 24 that extend over the entire length of the webbing. Preferably, the heating elements 26 or at least the carriers 30 of the heating element equally extend over the entire length of the webbing 12, which facilitates simple manufacture of the webbing 12.

The electric heating element 26 accommodated in the respective chamber 24 may extend over the entire length of the respective chamber 24 or over a partial area only.

This helps define, inter alia, the heating surface available.

Via the number of the chambers 24 and, consequently, also the number of the electric heating elements 26 the maximally available heating capacity as well as the corresponding heating surface can be adjusted.

The electric heating elements 26 are especially band-shaped, therefore they can also be referred to as heating bands. Insofar, the electric heating elements 26 can be easily introduced to the chambers 24 of the webbing 12, i.e., during manufacture of the webbing 12.

Further, at its periphery the webbing 12 includes edges 28 that are formed during manufacture of the webbing 12.

For example, the webbing 12 comprises plural layers which are interconnected. The two peripheral or outer layers forming the edges 28 can be sewn, especially at the periphery, to each other.

Also, the plural layers can be interwoven, wherein also the two peripheral or outer layers forming the edges 28 are interwoven.

Basically, the chambers 24 may also be provided in one layer of the webbing 12.

The at least one layer of the webbing 12 may be a fabric layer that comprises, e.g., PET.

During the weaving process of the webbing 12, the electric heating elements 26 can be continuously fed so that the heating elements 26 are integrated already during manufacture of the webbing 12 so that they do not have to be introduced manually afterwards.

The heating elements 26 can be sewn directly with the material of the webbing 12 so as to be fastened to the webbing 12, and especially to a layer of the webbing 12.

Each of the heating elements 26 may comprise a carrier 30 and a heating material 32 that is applied to the carrier 30. The heating material 32 may be coupled to the carrier 30, such as sewn with the carrier 30, by embroidery and/or by means of crochet galloon technique.

The carrier 30 may be a non-woven or a fabric material to which the heating material 32 is appropriately fastened. Alternatively, the heating material 32 may be introduced or integrated in the carrier 30, for example woven into the carrier 30.

In particular, a heating element 26 designed in this way is prefabricated so that during the weaving operation it is directly introduced to the respective chamber 24 and is fastened in the webbing 12 during the weaving operation.

The heating material 32 may be loop-shaped so that the ends of the heating material 32, for example of a heating wire, are located at one end of the respective heating element 26. In other words, at the two ends of the loop the heating material 32 includes corresponding contacts 34 via which an electrical contact then can be applied to the electric heating element 26.

The heating material 32 may be arranged only in portions on the carrier 30. This allows, for example, endless introduction/interweaving of the heating element 26 during the manufacturing process of the webbing 12, wherein the available heating surface can be defined through the portion of the carrier 30 and, resp., the portions of the carriers 30 on which the heating material 32 is arranged.

The at least one electric heating element 26 can be easily contacted through the end fitting 16 of the seat belt 10.

Hence, the heating element 26 is passed, at least with its contacts 34, up to the end fitting 16. The contacts 34 thus can extend through the webbing 12.

In particular, all of the contacts 34 of the heating elements 26 that are accommodated in different chambers 24 are passed out at one end of the webbing 12, namely at the end of the webbing 12 assigned to the end fitting 16.

Furthermore, at least some areas of the heating elements 26 may be provided, for the protection, e.g., against water, sweat or abrasion, with an insulation 36, may include an insulating coating and/or may be surrounded by a separately configured insulation, for example.

Also, the heating material 32 itself can include the insulation 36, and thus can be appropriately insulated.

For example, the heating material 32 comprises at least one conductive fiber element and/or one conductive stranded element. The conductive stranded element may comprise, for example, a copper strand and/or a steel strand including a copper coating with an enamel insulation. The conductive fiber element may comprise, for example, a conductive filament and/or a carbon fiber with an enamel insulation.

1-11. (canceled)

12. A seat belt (10) for a motor vehicle, comprising a webbing (12) that includes at least one chamber (24) in which at least one electric, especially band-shaped, heating element (26) is accommodated.

13. The seat belt according to claim 12, wherein there are provided plural chambers (24) in each of which at least one electric heating element (26) is accommodated, especially wherein the chambers (24) are arranged in parallel to each other.

14. The seat belt according to claim 12, wherein the at least one chamber (24) extends at least over a partial area (22) of the webbing (12) in the longitudinal direction, and/or in that the at least one chamber (24) has a width of 3 to 5 mm.

15. The seat belt according to claim 12, wherein the electric heating element (26) comprises at least one carrier (30) on which at least one heating material (32) is disposed, especially wherein the heating material (32) is loop-shaped.

16. The seat belt according to claim 15, wherein the heating material (32) has been embroidered onto the carrier (30).

17. The seat belt according to claim 15, wherein the heating material (32) is insulated at least in some areas, especially wherein an insulated heating material (32), such as at least one copper strand with an enamel insulation, is provided.

18. The seat belt according to claim 12, wherein the seat belt (10) includes an end fitting (16) at which an electrical contact is applied to the electric heating element (26).

19. A method for manufacturing a seat belt (10) for a motor vehicle, comprising the steps of:
providing a webbing (12) including at least one chamber (24) and at least one electric, especially band-shaped, heating element (26), and
arranging the electric heating element (26) in the at least one chamber (24) of the webbing (12).

20. The method according to claim 19, wherein the webbing (12) is fabricated together with the electric heating element (26) in a weaving process, especially wherein the electric heating element (26) is continuously fed during the weaving process of the webbing (12).

21. The method according to claim 19, wherein the electric heating element (26) comprises a carrier (30) and a heating material (32) that is embroidered onto the carrier (30), especially wherein the electric heating element (26) is prefabricated.

22. The method according to claim 19, wherein the electric heating element (26) is insulated at least in some areas, especially the heating material (22).
